(19) United States
(12) Patent Application Publication
(10) Pub. No.: US 2014/0278624 A1
(43) Pub. Date: Sep. 18, 2014

(54) System and Method For Automatically Disseminating Information And Queries Concerning External Organizations To Relevant Employees

(71) Applicant: NORTHROP GRUMMAN SYSTEMS CORPORATION, Falls Church, VA (US)

(72) Inventor: Donald Steiner, McLean, VA (US)

(73) Assignee: NORTHROP GRUMMAN SYSTEMS CORPORATION, Falls Church, VA (US)

(21) Appl. No.: 14/194,020

(22) Filed: Feb. 28, 2014

Related U.S. Application Data
(60) Provisional application No. 61/777,206, filed on Mar. 12, 2013.

(51) Int. Cl. G06Q 10/06

(52) U.S. Cl. CPC G06Q 10/0631
USPC 705/7.12

(57) ABSTRACT

A system and method for automatically disseminating information and queries concerning external organizations to relevant employees is disclosed. Embodiments provide a mechanism for automatically disseminating information and queries concerning an external organizational entity (such as a partner, vendor, or customer) to those and only those staff members in an organization for whom the information or query may be relevant. The method comprises filtering incoming and outgoing messages. The filtering identifies a domain name associated with a sender of each incoming message or a recipient of each outgoing message. The method also comprises determining whether the identified domain name exists in an index. Such dissemination may take place through the system automatically forwarding relevant email or automatically through an interface to be used by the initiator of the information or query. Employees may trigger the dissemination via tagging the relevant email with the domain of the external organizational entity.

### CROSS REFERENCE TO RELATED APPLICATION(S)

This application claims priority from U.S. Provisional Patent Application. No. 61/777,206, filed on Mar. 12, 2013, which is hereby incorporated herein by reference in its entirety.

### BACKGROUND

In large organizations, it is difficult to readily find out who already has knowledge about a certain subject. Much time is wasted in either locating these people or re-acquiring the knowledge about the certain subject. It is difficult to identify those members in an organization for whom information and queries about other organizations may be relevant. Consequently, it is also difficult to get new information or queries to the right people who could use the information or answer the queries.

For example, a company X may have a number of people who have interacted with another company Y. However, the identity of these people is unknown at any given level in the organization. The people responsible for strategic partnerships at company X may not even know how many people in the organization are interacting with company Y. Company Y may or may not be forthcoming about whom they interact with at company X, depending on their business motivations. In order to improve corporate efficiency and to reduce costs, it is necessary to be able to internally quickly get information about the people who have interacted with company Y.

For example, Christine from a strategic partnerships division might be able to use the fact that company Y has been in active discussions with over, e.g., sixty (60) different people at company X as a bargaining point to get company Y to reduce their fees. If a fee reduction has been accomplished, Christine would like to send out notification thereof to all those employees at company X interacting with company Y so they are aware of and will take advantage of the reduced price. Another example is Tom from company X who just learned about company Y and is interested in considering them for deployment in a solution for his customer. He would like to know about their reliability and quality from others at company X who have previously used them. He currently has no means or, at best, limited means to access those people at company X who already have experience with company Y.

Identification and corresponding dissemination of information to individuals in a company for whom the information may be relevant is currently haphazard and inefficient. Such identification and dissemination that occurs is primarily accomplished by the following methods:
1) Personal knowledge: Hard to keep up-to-date and accurate in large organizations.
2) Networking and word of mouth: Sending emails to initial contacts with a request that it be forwarded to whomever may be interested. This is usually haphazard, creates unnecessary emails and email chains, is slow and is unreliable.
3) Comprehensive addressing: Sending emails to all members of the organization or high level groups. These are often regarded as spam and, therefore, disregarded, contributing to information overload.
4) Explicit subscription to email distribution lists. This approach needs corresponding lists to be identified and created. It is difficult to maintain comprehensive list categories, subscriptions to lists and keep people aware of all available lists.
5) Subscription to automated feeds (e.g., RSS). This requires users to be aware of and subscribe to corresponding RSS feeds. Such RSS feeds are often too general, resulting in information overload, or are too specific, resulting in poor targeting.

In most of the above cases, every user is required to perform some initialization of update action in order to participate effectively in the information dissemination process; this in itself is cumbersome and annoying, and thus most users will not actually do this.

There are a number of email archival and data mining products that analyze email archives automatically. However, these archival and data mining products are expensive to implement, require storing huge amounts of data, and sacrifice privacy concerning content of email. RSS feeds require look up and subscription on part of users that is unwieldy and often overly general. Dynamic distribution lists use Active Directory or other assignment of entries that need to be actively maintained. Consequently, the state of the art does not provide an effective system or method for automatically disseminating information and queries concerning external organizations to relevant employees.

### SUMMARY

Embodiments are directed to a computer-implemented method for automatically disseminating information and queries concerning external organizations to relevant employees. The method includes: a) filtering incoming and outgoing messages, in which the filtering identifies a domain name associated with a sender of each incoming message or a recipient of each outgoing message; b) determining whether the identified domain name exists in an index that includes a plurality of domain names; c) if the identified domain name does not exist in the index, determining if the identified domain name should be excluded; d) if the identified domain name should not be excluded, adding the identified domain name to the index and determining if an internal user receiving each incoming message or sending each outgoing message is listed in an index entry for the identified domain name, wherein each domain name in the index has at least one index entry listing one or more internal users; e) if the internal user is not listed in the index entry for the identified domain name, adding the user to the index entry for the identified domain name; f) receiving a request to send a new message to users listed in the index entry for the identified domain name; and g) sending the new message to users listed in the index entry for the identified domain name.

The request may be triggered via insertion of an item selected from the group consisting of a metadata tag, email address, website, code name, code word, code phrase, hashtag, domain name, and combinations thereof, within the new message to be sent to the users listed in the index entry for the identified domain name.

In an embodiment, if the identified domain name should be excluded, the method returns to and repeats a through g, as appropriate, for any additional incoming or outgoing message.

In an embodiment, if the identified domain name exists in the index, the method determines if an internal user receiving each incoming message or sending each outgoing message is listed in an index entry for the identified domain name.

In an embodiment, the method may further increment a counter of internal users listed in the index entry for the identified domain name.

In an embodiment, the method may further add additional information to the index entry for the identified domain name.

In an embodiment, the method may further receive a request for statistics or data associated with the identified domain name, determine requested statistics or data associated with the identified domain name and send requested statistics or data associated with the identified domain name.

Embodiments are also directed to a system for automatically disseminating information and queries concerning external organizations to relevant employees. The system includes similar features that correspond to the above-mentioned method.

Embodiments are further directed to a non-transitory computer readable medium comprising instructions, executable by a processor, for automatically disseminating information and queries concerning external organizations to relevant employees. The instructions include instructions for performing the above-mentioned method.

### BRIEF DESCRIPTION OF THE DRAWINGS

For the present invention to be clearly understood and readily practiced, embodiments will be described in conjunction with the following figures, wherein:

The detailed description will refer to the following drawings in which like numerals refer to like items, and in which:

FIG. 1 is a flowchart illustrating an embodiment of a method for automatically disseminating information and queries concerning external organizations to relevant employees.

FIG. 2 is a block diagram illustrating an embodiment of a computer system that may be used in embodiments of a system for automatically disseminating information and queries concerning external organizations to relevant employees.

### DETAILED DESCRIPTION

It is to be understood that the figures and descriptions of the present invention may have been simplified to illustrate elements that are relevant for a clear understanding of the present invention, while eliminating, for purposes of clarity, other elements found in a typical information and query dissemination system or typical information and query dissemination method. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

Described herein are embodiments of a system and method for automatically disseminating information and queries concerning external organizations to relevant employees. Embodiments provide a mechanism for automatically disseminating information and queries concerning an external organizational entity (such as a partner, vendor, or customer) to those and only those staff members in an organization for whom the information or query may be relevant. Such dissemination may take place through the system automatically forwarding relevant email or automatically through an interface (possibly web-based) to be used by the initiator of the information or query. Embodiments of the system and method also allow collecting and browsing of statistics of email-based interactions with external entities. Embodiments are based on a high-level analysis of headers of email exchanges. Embodiments avoid spamming while preserving security and privacy. Embodiments are lightweight and easy to implement and deploy. Embodiments automatically direct queries or messages about a subject to mainly those people who already have knowledge of the subject and/or to those people who have previously interacted with employees of the external entities.

Embodiments increase corporate efficiency and corporate-wide awareness of partnership information by targeted dissemination of the right information to the right people, in particular automatically sending information and queries about external organizations to those people within an organization who have previously interacted with the external organizations.

Embodiments of a system and method for automatically disseminating information and queries concerning external organizations to relevant employees may be implemented in two primary steps with a third optional means of access and use. In an embodiment, an index of salient information about emails exchanged with external domain names (e.g., representing partners, vendors, customers, competitors, etc.) is built and dynamically updated based on outgoing and incoming emails. The index maintains external domain names associated with those staff members who have sent email to and/or received email from addresses at the corresponding external domain names. The index may also include date, subject, size of the email as derived from an email header, and other metadata but need not necessarily include the actual content (body) of the email. The index itself may be maintained in a secure location and may be only accessible to system administrators. In embodiments, the index is automatically generated and maintained without any intervention by the users. In particular, users do not have to explicitly register contacts, their domain names, their websites, their email addresses, or the like. Other embodiments may automatically log all email interaction in a system log or other database which may comprise more information than the above index. In this case, an embodiment may extract the required salient information from the system log or database without necessarily maintaining a separate index.

When an employee wishes to send an email/message about an external entity (concerning, for example, either a query, announcement, and/or other information) to all those staff members to whom the email may be relevant, the employee sends the email to a given email address in the “To:” or destination field (e.g., twimc@ngc.com) with a subject containing the domain name of the external entity. Alternatively, this triggering of the system or tagging of the email may be effected by placing a metadata tag, email address, website, code name/word/phrase, hashtag, and/or domain name at any previously determined location (e.g., subject, body, header) within the email. The given email address may be an internal email address (i.e., within the employee's company). Alternatively, the given email address may be an external email address (i.e., outside the employee's company). When using the external domain name in the subject as the trigger, or upon any of the other aforementioned triggering mechanisms, the system uses the aforementioned index to look up the staff members who have exchanged emails with this external domain name, and the email is forwarded to all of those staff members, e.g., as a “blind carbon copy.” Consequently, in this exemplary scenario, the staff members who have been identified as being relevant know who sent the email, but there is no way for the staff members to know any others to whom the email is being sent. Thus, the recipients of the email do not know the identity of the other recipients and the recipients remain anonymous, unless they want to identify themselves in subsequent follow-on or reply emails. This maintains the index and the list of people in the index as secure and confidential information.

Embodiments may also provide an (e.g., web-based) interface to the index to enable users to quickly look-up statistics of the index, such as, e.g., the number of employees corresponding to certain domain names. This interface can also be used to generate emails to the relevant employees

With reference now to FIG. 1, shown is a flowchart illustrating an embodiment of computer-implemented method 100 for automatically disseminating information and queries concerning external organizations to relevant employees. FIG. 1 illustrates building of an index of salient information described above and use of the index. The index may be kept as a table or other database of entries for domain names indicating users (e.g., employees that have received and sent e-mails to the domain name. Method 100 filters outgoing and incoming email (e.g., of an enterprise, governmental unit, etc.), block 102. The filtering identifies domain names of the recipients of the outgoing email and of the senders of the incoming email. Embodiments determine if the identified domain name already exists in the index, block 104. If the domain name already exists in the index, embodiments determine if the user that sent or received the email is already listed in the index entry for the identified domain name, block 106. If the user is not listed in the index entry for the domain name, the employee is added to the index entry, block 108. Additional information, e.g., key words found in the email, specific addressee(s), etc., may be added to the index entry for the domain name. Each index entry may also keep a record of the number of times a user sent or received emails to and from the identified domain name. If the user was already listed in the index entry for the domain name, a counter indicating the number of times a user sent or received emails to and from the identified domain name may be incremented (and additional information from message may be added), block 110.

If the identified domain name does not already exist in the index, embodiments may determine if the domain name should be excluded from the index, block 112. A domain name may be excluded if, e.g., it is a domain name used for personal e-mails. Many domain names, such as gmail.com, yahoo.com, Hotmail.com, comcast.net, etc., are internet-service provider or internet-email provider domain names typically used for personal e-mails. Such domain names will generally be excluded from the index. However, if a specific address for such a domain name is used for a non-personal use (e.g., business, scholastic, government, etc.), that specific address may be added to the index. Embodiments may determine 112 if the domain name should be excluded by reference to an exclusion list set up by a system administrator. If a domain name is excluded, method 100 may return to filtering 102 messages.

With continuing reference to FIG. 1, if the domain name is not excluded, method 100 may add the domain name to the index, creating an entry in the table or other database for the domain name, block 114. After the domain name entry is created, method 100 may return to the main flow, e.g., determining 106 if the employee that sent or received the email is already listed in the index entry for the identified domain name, wherein each domain name in the index has at least one index entry listing one or more internal users. The domain names in the index have at least one index entry listing one or more internal users.

In some embodiments, users may set up a system so that the user will be automatically notified any time another employee sends or receives a message from an identified domain name. Users may do this by using an interface that provides access to the index. Accordingly, method 100 may automatically notify users that have requested automatic notification of receipt or sending of emails to the identified domain name, block 116. Such automatic notification may simply be an email, text alert or an alert displayed on the user's computer display. Method 100 may not necessarily display the name of the other employee, it may just indicate that a message has been sent to or received from the domain name. Alternatively, the method 100 may display the entire message or a portion of the message.

Additionally, users may send messages from time to time to those relevant employees that have received or sent emails to a given domain name. Method 100 may receive a request to send a new message to all users listed in the entry for a domain name, block 118. The request may be received via an e-mail sent to the system or through a system interface, as described above. For example, the request may be in the form of an email where the employee sends an email with a subject containing the domain name of the external entity or other trigger as described above. Upon receiving the request, method 100 may send the new message as requested to the listed users, block 120. In some embodiments, some users may elect to not receive such messages. Consequently, embodiments may not send 120 messages to those users so electing. Users may also request statistics or other data about emails sent and received from domain names. Such requests may be made through the system interface, as described above, or through other means (e.g., emails to the system). Accordingly, method 100 may receive request for statistics or other data, block 122, and may determine and send such requested statistics or other data, block 124. Any of method steps 118-124 may be performed repeatedly and independently of the preceding steps.

With reference now to FIG. 2, shown is a block diagram illustrating exemplary hardware components for implementing embodiments of a system and method for automatically disseminating information and queries concerning external organizations to relevant employees. Server 200, or other computer system similarly configured, may include and execute one or more subsystem components to perform functions described herein, including steps of method 100 described above. Likewise, a mobile device which includes some of the same components of computer system 200 may run application and perform steps of method 100 described above. Computer system 200 may connect with network 222, e.g., Internet, or other network, to receive inquires, obtain data, and transmit information and incentives as described above.

Computer system 200 typically includes a memory 202, a secondary storage device 204, and a processor 206. Computer system 200 may also include a plurality of processors 206 and be configured as a plurality of, e.g., bladed servers, or other known server configurations. Computer system 200 may also include an input device 208, a display device 210, and an output device 212. Memory 202 may include RAM or similar types of memory, and it may store one or more applications for execution by processor 206. Secondary storage device 204 may include a hard disk drive, floppy disk drive, CD-ROM drive, or other types of non-volatile data storage. The index, described above, may be stored in the secondary storage device 204 (e.g., on a permanent basis) or in memory 202 (e.g., on a temporary basis). Processor 206 executes the application(s), such as subsystem components, which are stored in memory 202 or secondary storage 204 or received from the Internet or other network 22 The processing by processor 206 may be implemented in software, such as software modules, for execution by computers or other machines. These applications preferably include instructions executable to perform the system and subsystem component (or application) functions and methods described above and illustrated in the FIGS. herein. The applications preferably provide graphical user interfaces (GUIs) through which users may view and interact with subsystem components (or application in mobile device). These interfaces may include interfaces described herein through which users may elect to disseminate emails/messages to all index members, view index information, etc.

Computer system 200 may store one or more database structures in secondary storage 204, for example, for storing and maintaining databases, and other information necessary to perform the above-described methods. Alternatively, such databases may be in storage devices separate from subsystem components.

Also, as noted, processor 206 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the system (or application).

Input device 208 may include any device for entering information into computer system 200, such as a touch-screen, keyboard, mouse, cursor-control device, touch-screen, microphone, digital camera, video recorder or camcorder. The input device 208 may be used to enter information into GUIs during performance of the methods described above. Display device 210 may include any type of device for presenting visual information such as, for example, a computer monitor or flat-screen display (or mobile device screen). The display device 210 may display the GUIs and/or output from sub-system components (or application). Output device 212 may include any type of device for presenting a hard copy of information, such as a printer, and other types of output devices include speakers or any device for providing information in audio faun.

Examples of computer system 200 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 200 is shown in detail, system and method embodiments described herein may use multiple computer system or servers as necessary or desired to support the users and may also use back-up or redundant servers to prevent network downtime in the event of a failure of a particular server. In addition, although computer system 200 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, computer system 200, to perform a particular method, such as methods described above.

In sum, innovative aspects of embodiments are an index built by automatically analyzing email exchanges in order to subsequently automatically route email to relevant people in the company. The process implemented by embodiments is secure, transparent and automated for users while preserving their privacy and anonymity. Key advantages include, but are not limited to:
zero effort required on part of relevant users to whom information is being routed.
Participation is totally automatic, no sign-up or downloads required.
Minimal effort required on part of user sending information.
No download required—just knowledge of, for example, the external domain name, email address, metadata tag, code name/word/phrase, hashtag, and/or website to use to trigger the system.
Implementation effort is low while advantages gained are high.
Privacy, anonymity, and security are maintained throughout process.

The contemplated modifications and variations specifically mentioned above are considered to be within the spirit and scope of the present invention.

Those of ordinary skill in the art will recognize that various modifications and variations may be made to the embodiments described above without departing from the spirit and scope of the present invention. It is therefore to be understood that the present invention is not limited to the particular embodiments disclosed above, but it is intended to cover such modifications and variations as defined by the following claims.

1. A computer-implemented method for automatically disseminating information and queries concerning external organizations to relevant employees, the method comprising:
a. filtering incoming and outgoing messages, wherein the filtering identifies a domain name associated with a sender of each incoming message or a recipient of each outgoing message;
b. determining whether the identified domain name exists in an index that includes a plurality of domain names;
c. if the identified domain name does not exist in the index, adding the identified domain name to the index and determining if an internal user receiving each incoming message or sending each outgoing message is listed in an index entry for the identified domain name, wherein each domain name in the index has at least one index entry listing one or more internal users;
d. if the internal user is not listed in the index entry for the identified domain name, adding the user to the index entry for the identified domain name;
e. receiving a request to send a new message to users listed in the index entry for the identified domain name; and
f. sending the new message to users listed in the index entry for the identified domain name.

2. The computer-implemented method of claim 1 wherein the request is triggered via insertion of the identified domain name in the subject of the new message to be sent to the users listed in the index entry for the identified domain name.

3. The computer-implemented method of claim 1 wherein the request is triggered via insertion of an item selected from the group consisting of a metadata tag, email address, website, code name, code word, code phrase, hashtag, domain name, and combinations thereof, within the new message to be sent to the users listed in the index entry for the identified domain name.

4. The computer-implemented method of claim 1 wherein the new message is addressed in the destination field to an internal email address.

5. The computer-implemented method of claim 1 further comprising repeating a through f, as appropriate, for any additional incoming or outgoing message.

6. The computer-implemented method of claim 1 wherein if the identified domain name should be excluded, the method returns to and repeats a through f, as appropriate, for any additional incoming or outgoing message.

7. The computer-implemented method of claim 1 wherein if the identified domain name exists in the index, the method performs the determining if an internal user receiving each incoming message or sending each outgoing message is listed in an index entry for the identified domain name.

8. The computer-implemented method of claim 1 further comprising incrementing a counter of internal users listed in the index entry for the identified domain name.

9. The computer-implemented method of claim 1 further comprising adding additional information to the index entry for the identified domain name.

10. The computer-implemented method of claim 1 further comprising:
receiving request for statistics or data associated with the identified domain name;
determining requested statistics or data associated with the identified domain name; and
sending requested statistics or data associated with the identified domain name.

11. The computer-implemented method of claim 1 further comprising determining if the identified domain name should be excluded from the index.

12. A system for automatically disseminating information and queries concerning external organizations to relevant employees, the system comprising:
a processor, wherein the processor executes instructions stored on a memory;
a memory that has thereon the instructions for execution by the processor including:
filtering incoming and outgoing messages, wherein the filtering identifies a domain name associated with a sender of each incoming message or a recipient of each outgoing message;
determining whether the identified domain name exists in an index that includes a plurality of domain names;
if the identified domain name does not exist in the index, determining if the identified domain name should be excluded;
if the identified domain name should not be excluded, adding the identified domain name to the index and determining if an internal user receiving each incoming message or sending each outgoing message is listed in an index entry for the identified domain name, wherein each domain name in the index has at least one index entry listing one or more internal users;
if the internal user is not listed in the index entry for the identified domain name, adding the user to the index entry for the identified domain name;
receiving a request to send a new message to users listed in the index entry for the identified domain name; and
sending the new message to users listed in the index entry for the identified domain name.

13. The system of claim 12 wherein the request is triggered via insertion of the identified domain name in the subject of the new message to be sent to the users listed in the index entry for the identified domain name.

14. The system of claim 12 wherein the request is triggered via insertion of an item selected from the group consisting of a metadata tag, email address, website, code name, code word, code phrase, hashtag, domain name, and combinations thereof, within the new message to be sent to the users listed in the index entry for the identified domain name.

15. The system of claim 12 wherein if the identified domain name exists in the index, the instructions include instructions for determining if an internal user receiving each incoming message or sending each outgoing message is listed in an index entry for the identified domain name.

16. A non-transitory computer readable medium comprising instructions, executable by a processor, for automatically disseminating information and queries concerning external organizations to relevant employees, by:
filtering incoming and outgoing messages, wherein the filtering identifies a domain name associated with a sender of each incoming message or a recipient of each outgoing message;
determining whether the identified domain name exists in an index that includes a plurality of domain names;
if the identified domain name does not exist in the index, adding the identified domain name to the index and determining if an internal user receiving each incoming message or sending each outgoing message is listed in an index entry for the identified domain name, wherein each domain name in the index has at least one index entry listing one or more internal users;
if the internal user is not listed in the index entry for the identified domain name, adding the user to the index entry for the identified domain name;
receiving a request to send a new message to users listed in the index entry for the identified domain name; and
sending the new message to users listed in the index entry for the identified domain name.

17. The non-transitory computer readable medium of claim 16 wherein the request is triggered via insertion of the identified domain name in the subject of the new message to be sent to the users listed in the index entry for the identified domain name.

18. The non-transitory computer readable medium of claim 16 wherein the request is triggered via insertion of an item selected from the group consisting of a metadata tag, email address, website, code name, code word, code phrase, hashtag, domain name, and combinations thereof, within the new message to be sent to the users listed in the index entry for the identified domain name.

19. The non-transitory computer readable medium of claim 16 wherein the instructions include instructions for determining if an internal user receiving each incoming message or sending each outgoing message is listed in an index entry for the identified domain name and these instructions are executed if the identified domain name exists in the index.

20. The non-transitory computer readable medium of claim 16 wherein the instructions include instructions for determining if the identified domain name should be excluded from the index.
